(19) United States
(12) Patent Application Publication
(10) Pub. No.: US 2014/0072781 A1
(43) Pub. Date: Mar. 13, 2014

(54) SKIN PRINT PRODUCTS

(71) Applicant: Ana Holc, Maribor (SI)

(72) Inventor: Ana Holc, Maribor (SI)

(21) Appl. No.: 14/025,645

(22) Filed: Sep. 12, 2013

Related U.S. Application Data
(60) Provisional application No. 61/699,996, filed on Sep. 12, 2012.

(51) Int. Cl. A44C 25/00; B32B 3/00

(52) U.S. Cl. CPC A44C 25/00; B32B 3/00
USPC 428/195.1; 63/35

(57) ABSTRACT

Some implementations of the present invention include a piece of jewelry, an accessory, a tool, a household product, a personal care product, or other product that comprises a two-dimensional or a three-dimensional, permanent rendering of a person's skin. In some cases, the skin print is from a celebrity. Additionally, in some cases, the skin print comprises an identifying feature that readily identifies the person from which the skin print was taken. Some non-limiting examples of such identifying features include a mole, a scar, and a dimple. Other implementations are also described.

### CROSS-REFERENCE TO RELATED APPLICATION

This application claims the benefit of U.S. Provisional Application No. 61/699,996, filed Sep. 12, 2012, and entitled “Celebrity Skin Print Products;” the entire disclosure of which is hereby incorporated by reference.

### FIELD OF THE INVENTION

The present invention relates in general to products that comprise a replica of a portion of a person's skin. More particularly, some implementations of the present invention include a piece of jewelry, an accessory, a tool, or another product that comprises a two-dimensional or a three-dimensional rendering of a portion of a person's skin. In some cases, this “skin print” includes a rendering of a portion of skin from a celebrity.

### BACKGROUND OF THE INVENTION

In many ways, ours is a culture of celebrity. Whether sports heroes, film actors, singers, members of royal families, religious leaders, or others, many members of the public love to hear news about famous people and to learn about their lives.

With great intensity, some people want to feel that they know a celebrity personally, or that such people otherwise have a personal connection with a celebrity. This desire to connect with celebrities is demonstrated by the fact that every day, millions of people read magazines and view online news stories about celebrities' lives. Moreover, many people buy perfumes, colognes, clothes from clothing lines, food products, and myriad other types of merchandise associated with celebrities. More recently, millions of people have begun to follow the online social media accounts of their favorite celebrities in order to receive messages that are personally written by such celebrities on a regular basis.

At least some implementations of the present invention relate to novel processes, methods, and resulting products that permit members of the general public to experience a connection with celebrities at an intimate level.

### BRIEF SUMMARY OF THE INVENTION

The present invention relates in general to products that comprise a replica of a portion of a person's skin. More particularly, some implementations of the present invention include a product that comprises a two-dimensional or a three-dimensional rendering of a portion of a person's skin. In some cases, this skin print includes a rendering of a portion of skin from a celebrity.

Implementation of the present invention takes place in association with a product that comprises a skin print. With respect to the product, the product can comprise virtually any suitable physical product that is capable of having a skin print disposed thereon. In this regard, some examples of suitable products include any suitable type of jewelry, tool, personal care product, and/or other item that is capable of having a permanent skin print disposed thereon. Indeed, in some cases, the product comprising a skin print is a piece of jewelry, such as a bracelet, locket, or a watch.

The skin print on the product can be derived from any suitable location on a person's skin, including, without limitation, from a portion of the person's palm, finger, face, or other suitable body part. Additionally, the skin print can be derived from any suitable individual, including, but not limited to, a random person; a skin model; a friend, child, sibling, parent, grandparent, or other relation of the person for whom the product with the skin print is intended; a celebrity; and/or virtually any other suitable person. In some implementations, however, the skin print is derived from the skin of a celebrity.

While the skin print can be made in any suitable manner, in some implementations, a two-dimensional or a three-dimensional rendering of the topography of a portion of a person's skin is obtained through the use of a molding material, a photograph, a two-dimensional or a three-dimensional scan or photograph, and/or any other suitable technique that is capable of providing a two- or a three-dimensional rendering of a portion of a person's skin. Additionally, in some implementations, the skin print on the product is produced through any suitable form of printing, etching, molding, plating, carving, adhesion, casting, deposition (e.g., chemical deposition or another suitable form of deposition), and/or any other suitable technique that is capable of forming the skin print on a suitable material, such as a metal, plastic, ceramic, wood, and/or other suitable material.

These features and advantages of the present invention will become more fully apparent from the following description and appended claims, or may be learned by the practice of the invention as set forth hereinafter.

### BRIEF DESCRIPTION OF THE SEVERAL DRAWINGS

In order that the manner in which the above-recited and other features and advantages of the invention are obtained and will be readily understood, a more particular description of the invention briefly described above will be rendered by reference to specific embodiments thereof that are illustrated in the appended drawings. Understanding that the drawings depict only some typical embodiments of the invention and are not therefore to be considered to be limiting of its scope, the invention will be described and explained with additional specificity and detail through the use of the accompanying drawings in which:

FIG. 1 depicts a perspective view of a representative embodiment of a ring comprising a skin print;

FIG. 2 depicts a perspective view of a representative embodiment of a cufflink comprising a skin print;

FIG. 3 depicts a back elevation view of a representative embodiment of a watch comprising a skin print;

FIG. 4 depicts a side elevation view a representative embodiment of an earring comprising multiple skin prints;

FIG. 5 depicts a perspective view of a representative embodiment of a bracelet comprising a skin print;

FIG. 6 depicts a front elevation view of a representative embodiment of a pendant comprising a skin print;

FIG. 7 depicts a perspective view of a representative embodiment of an elongated material comprising a skin print; and

FIG. 8 illustrates a back perspective view of an electronic device comprising a skin print.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment. Also, where reference is made to a list of elements (e.g., elements a, b, c), such reference is intended to include any one of the listed elements by itself, any combination of less than all of the listed elements, and/or a combination of all of the listed elements. Furthermore, as used herein, the terms a, an, and one may each be interchangeable with the terms at least one and one or more.

Furthermore, the described features, structures, or characteristics of the invention may be combined in any suitable manner in one or more embodiments. In the following description, numerous specific details are provided (such as examples of suitable types of jewelry, tools, personal care products, and other products that can have a skin print on them; portions of skin from which a skin print can be taken; suitable materials used to create the described products and skin prints; suitable methods for forming the described products; etc.) to provide a thorough understanding of embodiments of the invention. One having ordinary skill in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

In general, the present invention relates to systems and methods for creating a replica of a portion of a person's physical body and creating a product comprising that replica. In this regard, the replica can be of any suitable portion of a person's body, including, without limitation, of a person's hand, finger, nose, ear, and/or any other suitable body part. In some embodiments, however, the replica comprises a skin print. In other words, in some embodiments, the replica includes a two-dimensional and/or a three-dimensional reproduction of the topography of a portion of a person's skin (e.g., friction ridges, epidermal ridges, dermal papillae, pores, wrinkles, bend lines, creases, contours, and/or other features found on a person's skin). While such a skin print can comprise a three-dimensional replica of a body part (e.g., a replica of a finger, nose, ear, etc.) with the skin print disposed thereon, in some embodiments, the replica is simply of a portion of a person's skin, depicting the skin's topography.

Where the replica is of the topography of a person's skin (or where the replica comprises a skin print), the skin print can be obtained or otherwise derived from any suitable portion of a person's skin. Some examples of suitable portions of a person's skin from which the skin print can be taken include, but are in no way limited to, a portion of a person's face (e.g., nose, lips, chin, eyelid, cheeks, forehead, etc.); a portion of a person's mouth (e.g., tongue, teeth, etc.); a portion of one or more of a person's fingerprints, fingers (e.g., below a person's fingerprints), palms, toes, feet, knuckles, wrists, knees, ankles, fingernails, toenails, ears, elbows, arms, legs, etc.; a portion of a person's chest, torso, abdomen, back, navel, neck, and/or any other suitable body part. Although in some embodiments, the skin print comprises a fingerprint, in other embodiments, the skin print is devoid of fingerprints. In this regard, the skin print can be devoid of finger prints for any suitable reason, including, without limitation, for security and privacy reasons.

In some embodiments, the skin print comprises one or more identifying features. In this regard, the identifying feature can comprise a replica of any suitable portion of a person's skin that allow those who are familiar with that person to readily identify such person by viewing the identifying feature. In this regard, the identifying feature can comprise a scar (e.g., a pockmark, stretchmark, or other scar that can be used to identify a person, such as a celebrity), a mole (e.g., a mole, beauty mark, raised bump, or other similar feature is characteristic of a person), a dimple (e.g., a gelasin, indentation, cleft, or other form of dimple that could be used to identify a person), a lesion, a lip, a malformation, abnormality, a wrinkle pattern (e.g., crows' feet, forehead wrinkles, etc.), and/or other suitable feature that could be used to distinguish the person from which the skin print was obtained from others. In some embodiments, the identifying feature comprises a mole, scar, and/or other feature that can be used to readily identify the person from which the skin print was taken with the naked eye. For instance, in some embodiments, the identifying feature comprises a mole, scar, or other feature that allows one to identify the person from which the skin print with the identifying feature was taken, without any fingerprint analysis (or a similar analysis of skin friction ridges).

The skin print can be obtained from any suitable individual, including, without limitation, a celebrity; a person who one anticipates will be a celebrity; a person's child, spouse, girlfriend, boyfriend, mother, father, grandmother, grandfather, uncle, aunt, friend, or other relation; a skin model; a random person; and/or any other suitable individual. In some embodiments, however, the skin print is obtained from any suitable celebrity (e.g., an actor, singer, religious leader, member of a royal family, author, and/or other individual that is well-known in a particular culture or subculture).

The skin print can be placed on or otherwise included with virtually any suitable physical product that allows the skin print to be disposed on a viewable portion of the product. In this regard, skin print can be disposed on and/or within any suitable type or types of: jewelry (e.g., any suitable type of ring, necklace, choker, tore, pendant, locket, bracelet, armband, anklet, toe ring, tie clip, tie pin, cufflink, watch, crown, tiara, brooch, amulet, identification bracelet, identification tag, dog tag, pin, grill, prayer jewelry, puzzle jewelry, signet, cameo, medallion, jewelry finding, etc.); household product (e.g., paperweight, book cover, binder cover, journal cover, bookmark, picture frame, journal, book end, clock, door handle, cup, glass, cigarette case, case, etc.), apparel (e.g., belt, belt buckle, shoe, hat, glasses, jacket, coat, wallet, purse, etc.); personal care product (e.g., comb, fingernail clipper, hair clip/slide, curling iron, curler, file, etc.); tool (e.g., screwdriver, plier, utensil, etc.); accessories (e.g., key chain, souvenir, etc.); collectible; case; charm; cover; novelty product; disposable product; electronic device (e.g., cellphone, tablet, phablet, media player, calculator, laptop, phone, PDA, etc.); electronic device cover (e.g., cellphone cover, PDA cover, media player cover, laptop cover, etc.); paper product (e.g., business card); plaque; food product (e.g., chocolate, candy, sucker, etc.), and/or other suitable physical product that can comprise a skin print.

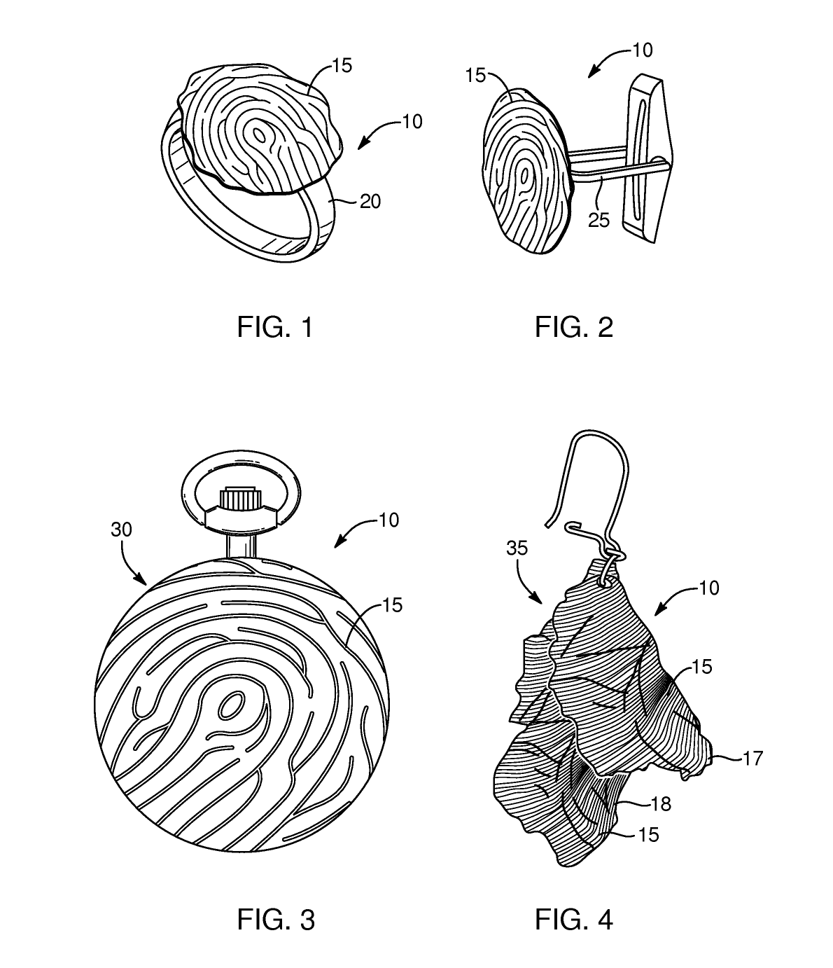

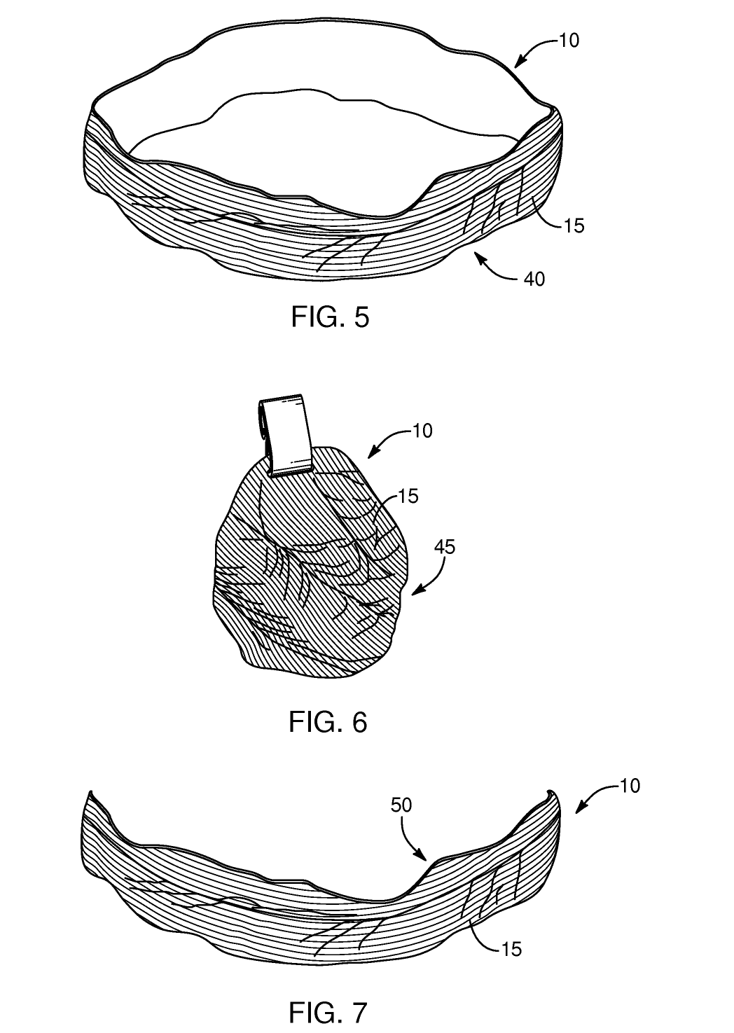

In some embodiments, however, the described product comprising a skin print (or skin print product) includes (or is included in) a piece of jewelry. While the skin print product can comprise any suitable type of jewelry, FIGS. 1-7 illustrate some non-limiting embodiments in which the skin print product 10 comprises jewelry. In particular, FIG. 1 shows a representative embodiment in which the skin print product 10 comprises a ring 20 having a skin print 15 disposed thereon. In another example, FIG. 2 shows a representative embodiment in which the skin print product 10 comprises a cufflink 25 having a skin print 15 disposed thereon. In another example, FIG. 3 illustrates a representative embodiment in which the skin print product 10 comprises a skin print 15 disposed on a watch 30. In another example, FIG. 4 illustrates a representative embodiment in which the skin print product 10 comprises a skin print 15 disposed on an earring 35. In another example, FIG. 5 illustrates a representative embodiment in which the skin print product 10 comprises a skin print 15 on a bracelet 40. In still another example, FIG. 6 illustrates a representative embodiment in which the skin print product 10 comprising a skin print 15 on a pendant 45. FIG. 7 further illustrates a representative embodiment in which the skin print product 10 comprises a skin print 15 on a strip of material 50 that can be used with a necklace, as a bookmark, a bracelet, and/or for a variety of other uses.

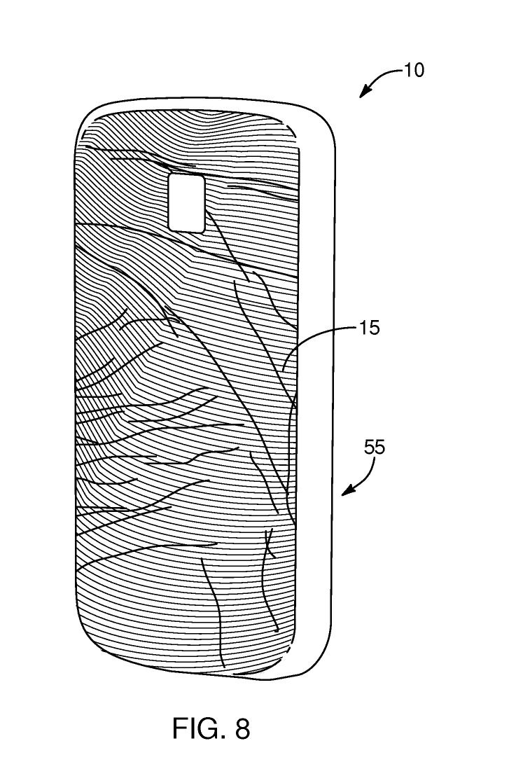

The skin print 15 can be disposed in any suitable location on the skin print product 10 that allows the skin print to be viewable or touchable. Indeed, in some embodiments, the skin print is disposed on an outer surface (e.g., as shown in FIG. 8, which illustrates a representative embodiment of an electronic device 55 (or an electronic device cover) comprising the skin print 15 on an outer surface), on an inner surface (e.g., in some embodiments in which the skin print product comprises a locket), and/or on another decorative surface of the skin print product.

The skin print product 10 can be made from any suitable material, including, without limitation, any suitable type of: precious metal (e.g., gold, white gold, platinum, palladium, silver, sterling silver, etc.), metal (e.g., stainless steel, bronze, metal alloy, etc.), precious stone, stone, clay, glass, wood, ceramic, bone, enamel, shell, rubber, polymer, plastic, nylon, acrylic, resin, thermoplastic resin, leather, and/or any other suitable material or combination of materials. In some embodiments in which the product comprising the skin print product comprises a piece of jewelry, the product comprise one or more metals (e.g., precious metals).

The skin print 15 can be derived or otherwise obtained from a person (e.g., a celebrity) in any suitable manner that allows the print to be included on a skin print product 10. Indeed, in some embodiments, an impression, image, and/or other rendering of a portion of a person's skin (namely the portion from which the skin print is to be obtained) is made via photocopy, photograph, scan, three-dimensional image, mold, printing/inking, and/or in any other suitable manner that is able to capture an image, impression, and/or other suitable rendering of a portion of a person's skin.

Once a rendering (e.g., a scan, mold, etc.) of a person's skin (e.g., a celebrity's skin) has been obtained using one or more of the techniques discussed above (or another technique as may be known to those skilled in the art), the skin print product 10 can be manufactured based on that two-dimensional and/or three-dimensional rendering (e.g., image, impression, etc.). This can be done in any suitable manner that provides the skin print product with a two-dimensional and/or a three-dimensional skin print (or representation of the topography of a portion of a person's skin). In some embodiments in which the skin print includes a two-dimensional representation of the topography of a portion of a person's skin, the skin print includes the pattern of the lines and the unique layout of the skin from which the print was obtained. Additionally, in some embodiments in which the skin print on the skin print product comprises a three-dimensional representation of the topography of a portion of a person's skin, the skin print includes the depth of skin features and the specific contours of the skin from which the print was made.

In one example of a suitable method for making a skin print 15, a desired portion of a person's skin (e.g., the hand, foot, or face of celebrity) is scanned (e.g., with a two-dimensional or a three-dimensional scanner), photographed, photocopied, and/or otherwise imaged. Once such an image is obtained, it may be printed on (e.g., via a two-dimensional and/or a three-dimensional printer), deposited on (e.g., via chemical vapor deposition or any other suitable method), plated on (e.g., via electroplating, electroless plating, gluing, gilding, and/or another suitable method), embossed on, carved in (e.g., via a machine or artist), stenciled on, drawn on (e.g., via a machine or artist), adhered to, and/or otherwise disposed on or in a desired skin product 10 (e.g., a piece jewelry).

In another example of a suitable method for making a skin print 15, a three-dimensional impression of a portion of a person's skin (e.g., celebrity's skin) is obtained by taking a mold of a portion of the person's skin (e.g., hand, foot, face, etc.). While this molding process can be accomplished in any suitable manner, in some embodiments, it includes contacting a person's skin with or against a soft, softened, and/or malleable material (which may include, but is not limited to, a silicone product). In this manner, the molding material is used to create a negative relief mold (or a reverse cast) into which a molding material (e.g., a metal, a precious metal, a thermoplastic, a resin, etc.) can be added (e.g., by being poured, pressed into, etc.). Once the molding material has been cooled, dried, baked, exposed to UV light, and/or otherwise allowed to harden, the molding material can be removed from the mold to expose a molded positive relief of the skin print.

In another example of a suitable method for making a skin print 15, a rendering of the topography of a portion of a person's skin is obtained by taking a mold of a desired portion of skin (e.g., hand, foot, face, etc.) using a soft, softened, and/or malleable material (e.g., a silicone product). Once the malleable material has been molded to include a desired skin topography (e.g., a negative relief of the skin design), the molded rendering of the skin is analyzed using one or more computer-based three-dimensional measuring tools. In this example, the information obtained from the three-dimensional measuring tools (or the three-dimensional information) can be used in any suitable manner. Indeed, in some embodiments, the three-dimensional information is transferred to a computer-numeric-controlled machine operating a router, laser, milling device, three-dimensional printer, and/or other device that operates on or with a suitable formable material (e.g., one or more resins; plastics; blank pieces of metal, precious metal, wood, glass, fiberglass, plastic, resin, and/or another suitable material; etc.). In other embodiments, the three-dimensional information is provided to a printing device (e.g., a three-dimensional printing device that prints the skin print). In still other embodiments, the three-dimensional information or a photograph is used by an artist to create the skin design.

In another example of a suitable method for making a skin print 15, a rendering of the topography of a portion of a person's skin is obtained using one of the methods described above, and that rendering is then used to create a reverse and/or a positive image and/or impression in a stamp or die (e.g., a metal die), using techniques as are known to those skilled in the art. In this example, the die is then used to stamp the three-dimensional skin design (or, in some embodiments, a negative relief thereof) onto a piece of material (e.g., a piece of wood, resin, fiberglass, leather, thermoplastic, metal, precious metal, or other suitable material).

In still another example of a suitable method for making a skin print 15, a rendering of the topography or a portion of a person's (e.g., a celebrity's) skin is obtained (e.g., via scanning, three-dimensional scanning tools, molding, and/or any other suitable method), and is then used in connection with one or more etching techniques and/or solutions to etch the skin print into a piece of material (e.g., a piece of metal, precious metal, wood, resin, glass, plastic, fiberglass, and/or suitable material).

In yet another example of a suitable method for making a skin print 15, the desired portion of a person's skin is molded, scanned, and/or otherwise obtained and then used to produce a positive relief of the skin print. In some such embodiments, the positive relief of the desired skin print is then used to create (e.g., via stamping, molding, etc.) a negative relief of the desired skin print.

In addition to the formation of the skin print 15, the skin print product 10 can be made in any suitable manner that allows the skin print to be included with the product. Indeed, in each of the methods discussed above, the material that contains the skin design can be processed into and/or attached to a finished product using any suitable standard or novel industrial forming process, including, without limitation, any suitable stamping, cutting, folding, filing, bending, molding, extrusion, adhesion, welding, soldering, polishing, and/or other suitable technique. Thus, while, in some embodiments, the skin print is formed directly into the material of the skin print product (e.g., before, as, or after the product is formed), in other embodiments, the skin print is attached to the product (e.g., before, as, or after the skin print product is formed). In any case, the result of these additional processing steps may thus yield the desired finished skin print product.

With regards to the shape of the skin print 15 on the skin print product 10, the skin print can be any suitable shape. Indeed, in some embodiments, the skin print itself is disposed on a three-dimensional replica of a portion of the person from which the skin print was taken. For example, the skin print can be disposed on a three-dimensional rendering of a finger, ear, nose, and/or other body part from which the skin print was taken. In other embodiments, however, the skin print simply comprises a print of skin topography (e.g., skin texture and layout) but is not included on a replica of a portion of the body from which the skin print was obtained. In this latter example, the skin print can have any suitable shape and be added to any other suitable object (e.g., as shown in FIGS. 1-8).

In some embodiments, a two-dimensional image (or other rendering) of a desired portion of a person's skin is used to create a three-dimensional skin print 15 (or a skin print with a positive or a negative relief). In some such embodiments, the skin print can be made to be three-dimensional in nature, while the dimensions of the contours, recesses, ridges, and other three-dimensional aspects of the skin print are derived from the two-dimensional rendering, assumed from the two-dimensional rendering, arbitrarily determined, artistically determined, and/or are otherwise determined without actually basing them on a three-dimensional rendering (e.g., mold, three-dimensional scan, etc.) of the person's skin from which the two-dimensional rendering was obtained. For instance, in some embodiments, the skin print product 10 (e.g., a piece of jewelry or a plastic case for an electronic device) comprises a printed, two-dimensional image of a skin print from a particular celebrity. In other embodiments, however, the skin print product comprises a portion that is molded with a three-dimensional skin print that was derived from a two-dimensional image, but where the three-dimensional aspect (e.g., the depth or height of the various features) of the skin print is not actually molded, cast, or otherwise based on an actual three-dimensional rendering (e.g., scan) of the topography portion of the skin from which the skin print was obtained.

The described skin print product 10 can be used in any suitable manner that allows the skin print 15 to be viewed, touched, or otherwise observed. Indeed, in some instances, the skin print product is worn, placed on display (e.g., a user's home, office, etc.), used in connection with other goods or services, and/or otherwise enjoyed as a means of feeling a deeper or more concrete, intimate, and personal connection to the particular person from whom the skin print was obtained (e.g., a particular celebrity).

In addition to the aforementioned characteristics, the described skin print product 10 can be modified in any suitable manner. Indeed, while, in some embodiments, the skin print 15 on the skin print product is life size, in other embodiments, the skin print (or a portion thereof) on the product is enlarged and/or miniaturized from its original size (or the actual size of the portion of the skin from which the skin print was taken). While the skin print can be enlarged or miniaturized in any suitable manner, in some embodiments, the skin print is proportionally scaled up and/or down to a desired size. In other embodiments, while the overall perimeter of the skin print on the product need not change, the depth and/or height of the contours and topographical features of the skin print can be increased (e.g., exaggerated) and/or decreased to provide the skin print with a desired appearance. For instance, to make the skin print appear that it came from a younger individual, some embodiments of the skin print comprise recesses (e.g., wrinkles) that are shallower than are the recesses in the actual skin that was used to create the skin print.

In another example of how the described skin print product 10 can be modified, instead of comprising a single skin print 15 (e.g., as shown in FIGS. 1-3 and 5-8), the product 10 (e.g., a piece of jewelry) can comprise any other suitable number of skin prints, including, without limitation, 2, 3, 4, 5, 6, 7, 8, 9, 10, or more. By way of non-limiting illustration, FIG. 4 shows an embodiment in which an earring 35 comprises two skin prints 17 and 18. Where the skin print product comprises multiple skin prints 15, the product can comprise any suitable combination of skin prints taken from any suitable portion of skin, from one or more individuals. In this regard, some embodiments of the product (e.g., a necklace, bracelet, etc.) comprise multiple discrete skin prints that are attachable to the product (e.g., as charms on a charm bracelet, as pendants on a necklace, or otherwise). In another example, the product itself comprises multiple skin prints formed in or otherwise disposed on the product. For instance, the skin print product can comprise a collage of skin prints, a collection of finger prints, and/or another suitable collection of skin prints.

In another example of how the described skin print product 10 can be modified, in some embodiments, the skin print 15 is stained or painted. In this regard, the skin print can be stained in any suitable manner, including, without limitation, such that recesses within the skin print comprise a higher concentration of the stain than do ridges or other processes that extend from three-dimensional renderings of the skin print.

In yet another example of how the skin print product 10 can be modified, while some embodiments of the skin print 15 comprise a human skin print, in other embodiments, the skin print on the skin print product is obtained from the skin (as opposed to the fur) of a specific animal. In such embodiments, the animal can comprise any suitable animal, including, without limitation, a person's pet and/or a famous animal.

In addition to the aforementioned characteristics, the skin print product 10 can offer several beneficial characteristics. For example, in at least some embodiments, the skin print 15 is permanently affixed to the skin print product, such that the skin print is configured to remain on the product for the life of the product. In such embodiments, the product and skin print can be cleaned and/or polished without removing or damaging the skin print.

In another example, the skin print product 10 can provide those who own, display, or otherwise use such products with an intimate and personal connection to the particular person (e.g., celebrity) from which the skin print 15 was obtained.

In still another example, the described skin print product 10 can be aesthetically pleasing. In still another example, the skin print product can comprise many of the characteristics of a person's (e.g., a celebrity's) skin without actually comprising that person's actual skin. In yet another example, the described skin print product can be a novelty that can draw attention, be a conversation piece, or otherwise remind people of the person from whom the skin print 15 was obtained.

The present invention may be embodied in other specific forms without departing from its spirit or essential characteristics. The described embodiments and examples are all to be considered, in all respects, only as illustrative and not as being restrictive in any manner. The scope of the invention is, therefore, indicated by the appended claims rather than by the foregoing description. All changes that come within the meaning and range of equivalency of the claims are to be embraced within their scope.

1. A skin print product, comprising:
a physical product having a decorative surface,
wherein the product comprises a human skin print permanently disposed on the decorative surface, and
wherein the human skin print includes a replica of a topography of a portion of skin from which the human skin print was obtained.

2. The skin print product of claim 1, wherein the physical product is selected from a piece of jewelry, a personal care product, an electronic device, an electronic device cover, a piece of apparel, a tool, and a household product.

3. The skin print product of claim 1, wherein the physical product comprises a piece of jewelry.

4. The skin print product of claim 3, wherein the piece of jewelry is selected from a pendant, a ring, a locket, a medallion, an amulet, a necklace, an earring, a cufflink, a tie pin, a tie clip, a hair clip/slide, a bracelet, a brooch, and a tag.

5. The skin print product of claim 1, wherein the human skin print comprises a positive relief.

6. The skin print product of claim 1, wherein the human skin print comprises a replica of a portion of skin from a celebrity.

7. The skin print product of claim 1, wherein the human skin print comprises a replica of an identifying feature of a person's skin that readily identifies the person without requiring an analysis of skin friction ridges.

8. The skin print product of claim 7, wherein the identifying feature is selected from a mole, a scar, a lesion, a lip, a malformation, a dimple, and a wrinkle pattern.

9. The skin print product of claim 7, wherein the identifying feature is selected from a mole, a scar, and a dimple.

10. The skin print product of claim 1, wherein the human skin print does not comprise a fingerprint.

11. The skin print product of claim 1, wherein the physical product is selected from a electronic device and a handheld electronic device cover.

12. A piece of jewelry, comprising:
a piece of jewelry having a decorative surface,
wherein the decorative surface of the piece of jewelry comprises a permanent human skin print depicting a topography of a portion of a person's skin.

13. The piece of jewelry of claim 12, wherein the human skin print does not depict a fingerprint from the person's skin.

14. The piece of jewelry of claim 13, wherein the human skin print comprises a replica of an identifying feature of the person's skin that readily identifies the person.

15. The piece of jewelry of claim 14, wherein the identifying feature is selected from a mole, a scar, and a dimple.

16. The piece of jewelry of claim 12, wherein the human skin print comprises multiple skin prints from at least one of multiple locations on the person's skin and multiple people.

17. The piece of jewelry of claim 12, wherein the human skin print comprises a positive relief of a portion of the person's skin from which the human skin print was obtained.

18. A skin print product, comprising:
a physical product selected from a piece of jewelry, a personal care product, a piece of apparel, a tool, an electronic device, and an electronic device cover,
wherein the physical product comprises a decorative surface,
wherein the product comprises a three-dimensional human skin print that is permanently disposed on the decorative surface, and
wherein the human skin print includes a replica of a topography of a portion of skin from which the human skin print was obtained.

19. The skin print product of claim 18, wherein the human skin print comprises a negative relief of the portion of the skin from which the human skin print was obtained.

20. The skin print product of claim 18, wherein a three-dimensional aspect of the human skin print does not directly correspond in size to the topography of the portion of skin from which the human skin print was obtained.
